(19) United States
(12) Patent Application Publication
(10) Pub. No.: US 2005/0271449 A1
(43) Pub. Date: Dec. 8, 2005

(54) Front loading printer with center justified print

(75) Inventors: Mark Hirte, Deerfield, IL (US); Robert P. Gotschewski, Schaumburg, IL (US); Jeffrey Paul Gotschewski, Elgin, IL (US); Edward Thomas, Round Lake Beach, IL (US); Martin Schwan, Chicago, IL (US); Kenneth Naegele, Vernon Hills, IL (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: ZIH Corp.

(21) Appl. No.: 11/049,281

(22) Filed: Feb. 2, 2005

Related U.S. Application Data
(60) Provisional application No. 60/481,996, filed on Feb. 2, 2004.

(51) Int. Cl. B41J 13/10

(52) U.S. Cl. 400/642

(57) ABSTRACT

A printer for printing indicia upon media having a frame defining a media cavity, the media cavity accessible for front loading of the media via a pivotable top cover carrying the print head. During media loading, a spindle supporting the media engages a pair of media guide rails located on opposing sides of the media cavity whereby the media is supported pushable to the rear of the media cavity into an operating position. A pair of movable centering guides are operable to center the media between them and with respect to the print head. An encoder may be coupled to the movable centering guides, to identify the media width to the printer, enabling the printer to adapt to the loading of a range of different media widths automatically. A front door carrying a take-up reel for media liner may be further incorporated into the printer.

### CROSS-REFERENCE TO RELATED APPLICATIONS

The present application claims priority from U.S. Provisional Patent Application No. 60/481,996 to Hirte et al., filed on Feb. 2, 2004, entitled: “Front Loading Printer With Center Justified Print,” the contents of which are hereby incorporated by reference.

### BACKGROUND OF THE INVENTION

1. Field of the Invention

The invention relates to printers, and more particularly to printers capable of printing on media that is center justified media.

2. Description of Related Art

Label printers have been adapted for extended operation via increased media capacity. Media may be supplied in roll form, for example 8-inch rolls, in a range of different roll widths depending upon the desired label dimensions. Prior printers adapted for roll media are typically side loaded by placing the media rolls upon side projecting media support arms. To accommodate different roll widths, the prior printers typically use left justified printing. That is, the printer processor assumes that the media is loaded against a far left fixed position, regardless of media width. One difficulty of left justified printing is that when narrow media is loaded, the print head may be unsupported on the right side—requiring additional structure and or latching of the print head into a fixed orientation with respect to the platen to ensure that the print head seats evenly upon the media, when narrow media is loaded.

To protect the media and print head from environmental fouling, the media and media delivery path across the print head and including a media liner take-up spindle, if used, are typically enclosed within the printer. Loading the printers with large and relatively heavy, for example, 8-inch diameter media rolls is difficult for operators. Side loading configurations allow the operator to directly load the media upon the side projecting media support arms and then route media through the media delivery path. Routing the media through a serpentine media delivery path, past and around the various spindles and media guide surfaces, during media exchange is time consuming, reducing overall printing throughput.

Printed labels are presented to the operator at the front of the printer. Side access and or side access door swing space requires that the user position each printer for use with additional free space/access alongside. In installations where desktop space is scarce and or where multiple printers are co-located to allow continuous printing availability during media exchange, the additional space required by side loading printers becomes significant.

Competition in the printer industry has focused attention upon improving overall print speed/quality, printer footprint and required service access space reduction, ease of use and reduction of manufacturing materials and operations costs.

Therefore, it is an object of the invention to provide a printer that overcomes deficiencies in such prior art.

### BRIEF SUMMARY OF THE INVENTION

The present invention provides systems and methods for facilitating center alignment of media in a printer. Specifically, the present invention provides guide rails located in the printer to support the spindle on which the media is located. The rails include depressions that mate with the spindle and resist rotation of the spindle as media is paid from the spindle. Further the guides may include top edges that slope toward the depressions to facilitate loading of the media and location of the media in the depressions.

Either alternatively or in addition to the guide rails, the systems and methods of the present invention may also provide a centering mechanism. The centering mechanism includes two centering guides located on opposite edges of the media. The centering mechanism may include racks connected to each of the centering guides and at least one pinion connecting the racks. In this embodiment, when one guide is moved, the other guide is also moved by the action of the racks and pinions. Specifically, the centering guides are moved a proportionate distance on either side of a center line from each other so as to ensure that the media is centered in the printer.

A detector may be connected to the centering mechanism to determine the spaced apart distance between the centering guides. From this distance, the invention can determine the width of the media.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an isometric view of a label printer, access doors closed, according to an exemplary embodiment of the invention.

FIG. 2 is an isometric right side view of the label printer of FIG. 1, access doors open according to one embodiment of the present invention.

FIG. 3 is an isometric elevated left side view of the label printer of FIG. 1, access doors open according to one embodiment of the present invention.

FIG. 4 is an elevated isometric view of the media loading area, media omitted, of the label printer of FIG. 1 according to one embodiment of the present invention.

FIG. 5 is an elevated isometric view of the media loading area, media roll inserted, of the label printer of FIG. 1 according to one embodiment of the present invention.

FIG. 6 is an isometric right side facing back to front view of the cavity, guide rails, and centering mechanism of the label printer of FIG. 1 according to one embodiment of the present invention.

FIG. 7 is an isometric right side facing up view of the cavity, guide rails, and centering mechanism of the label printer of FIG. 1 according to one embodiment of the present invention.

FIG. 8 is an isometric right side view of the guide rails of the label printer of FIG. 1 according to one embodiment of the present invention.

FIG. 9 is an isometric right side facing up view of the centering mechanism of the label printer of FIG. 1 according to one embodiment of the present invention.

FIG. 10 is an isometric right side facing up view of the cavity, guide rails, and centering mechanism of the label printer of FIG. 1 according to one embodiment of the present invention.

FIG. 11 is a front isometric view of the media loading and label liner rewind areas, media omitted, of the label printer of FIG. 1.

FIG. 12 is an isometric, close-up view of the label liner rewind area, media omitted, of the label printer of FIG. 1.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

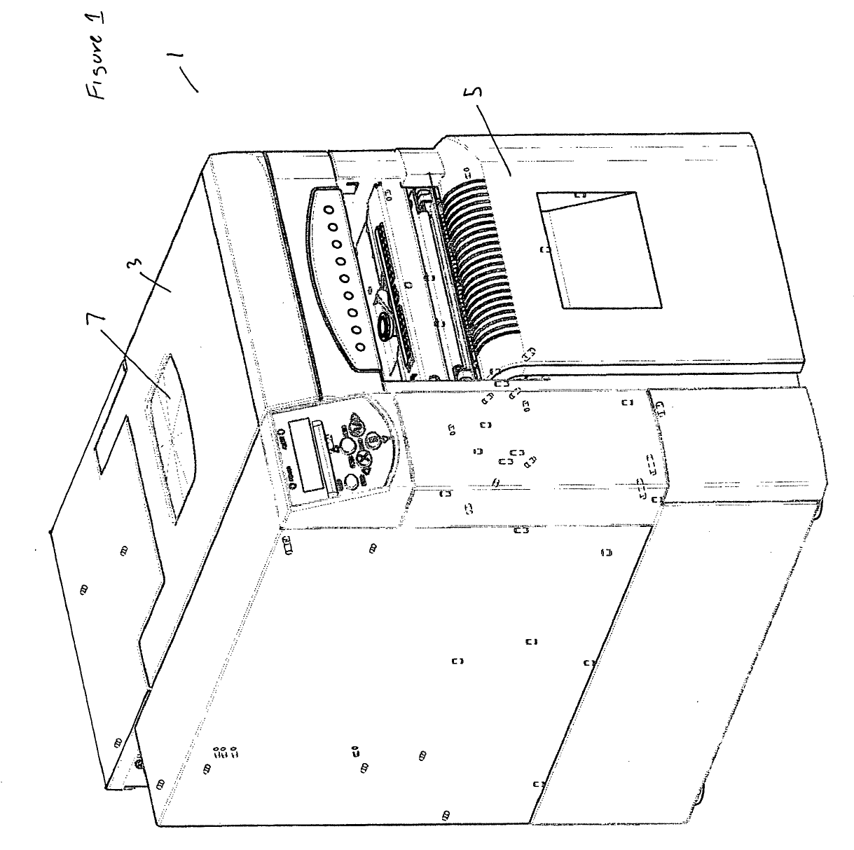

An exemplary embodiment of the invention, in the form of a label printer 1, including optional label liner rewind capability, is shown in FIG. 1. The label printer 1 has two media access doors, a top door 3 and a front door 5. The top door 3 may include a media window 7 through which an operator may quickly visually verify the presence, type and remaining volume of loaded print ribbon and or media 9.

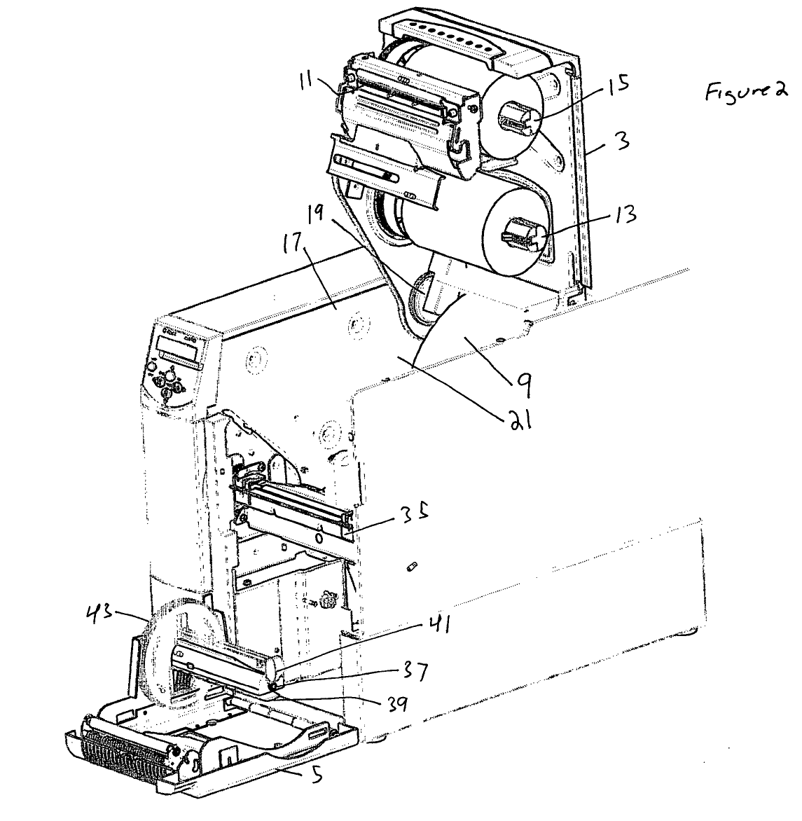

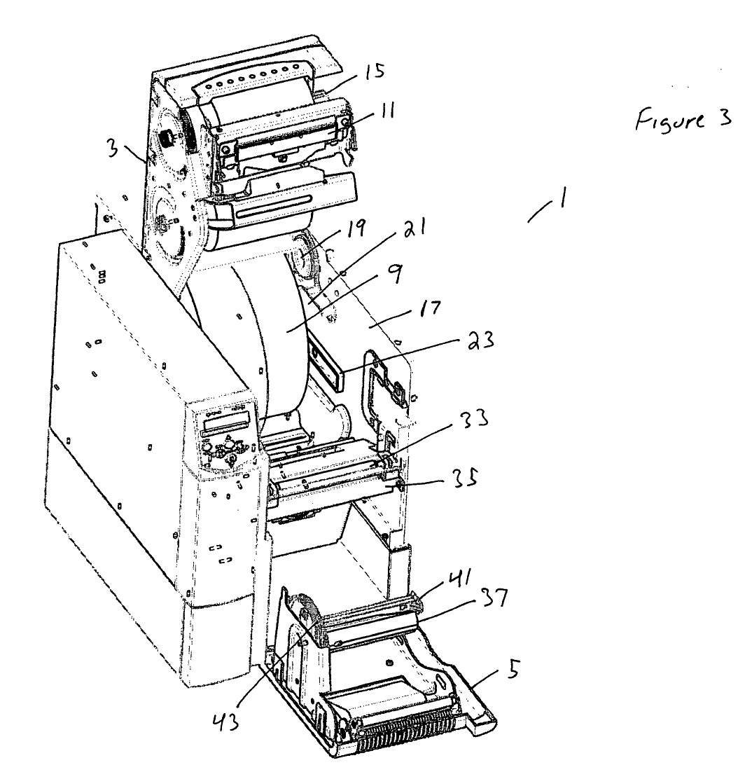

As shown in FIGS. 2 and 3, the top door 3 may be raised to access and or load the media 9. The print head 11, ribbon supply spindle 13 and ribbon take-up spindle 15 are attached to the top door 3. When the top door 3 is opened, the print head 11 and ribbon spindles are raised up and away from the media supply path, allowing front-loading access of the media 9. The media 9, in the form of, for example, labels on liner material is supplied in bulk rolls of a desired roll width.

The top door 3 is pivotably coupled to the frame 17 of the label printer 1 at pivot points 19 on either side of a media cavity 21. The pivot points 19 are selected to be at positions on either side of the media cavity 21 which allow the top door 3 to pivot open and allow insertion of the largest desired roll of media 9 usable with the label printer 1. Additionally, the top door 3 may be configured to pivot upwards to a position short of extending behind the label printer 1 so that space behind, in addition to directly adjacent the perimeter of the label printer 1 need not be available to enable printer operation and or media exchange.

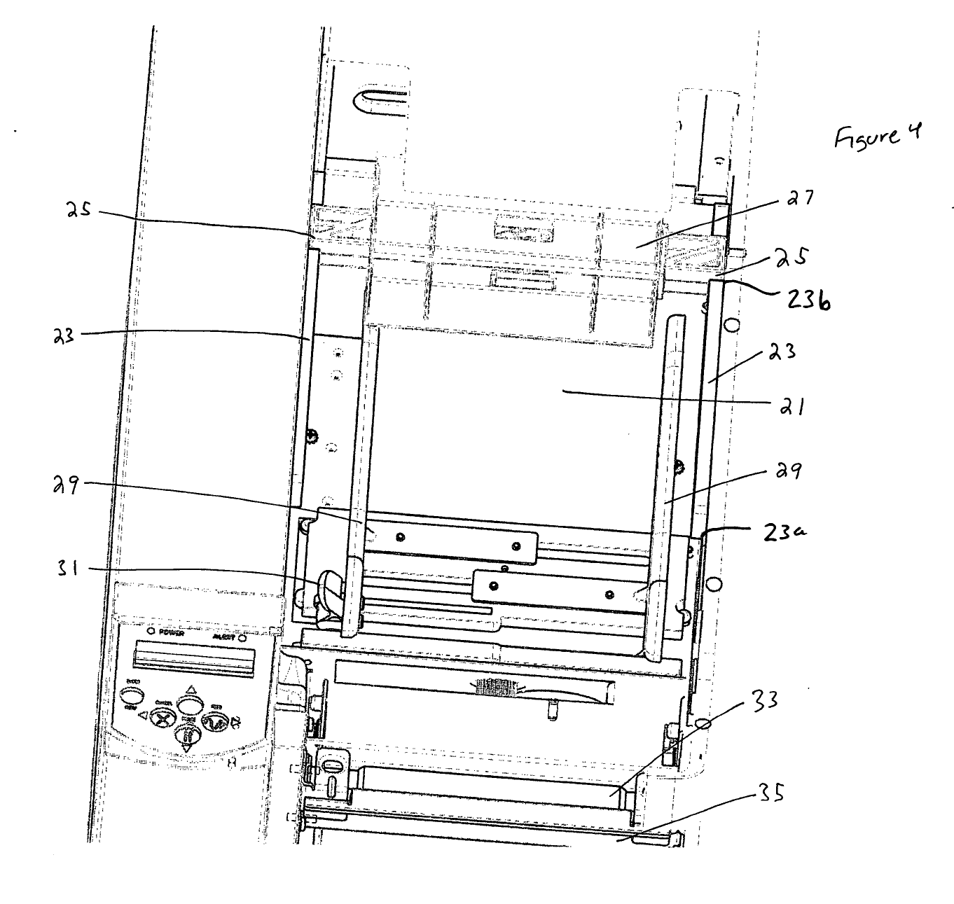

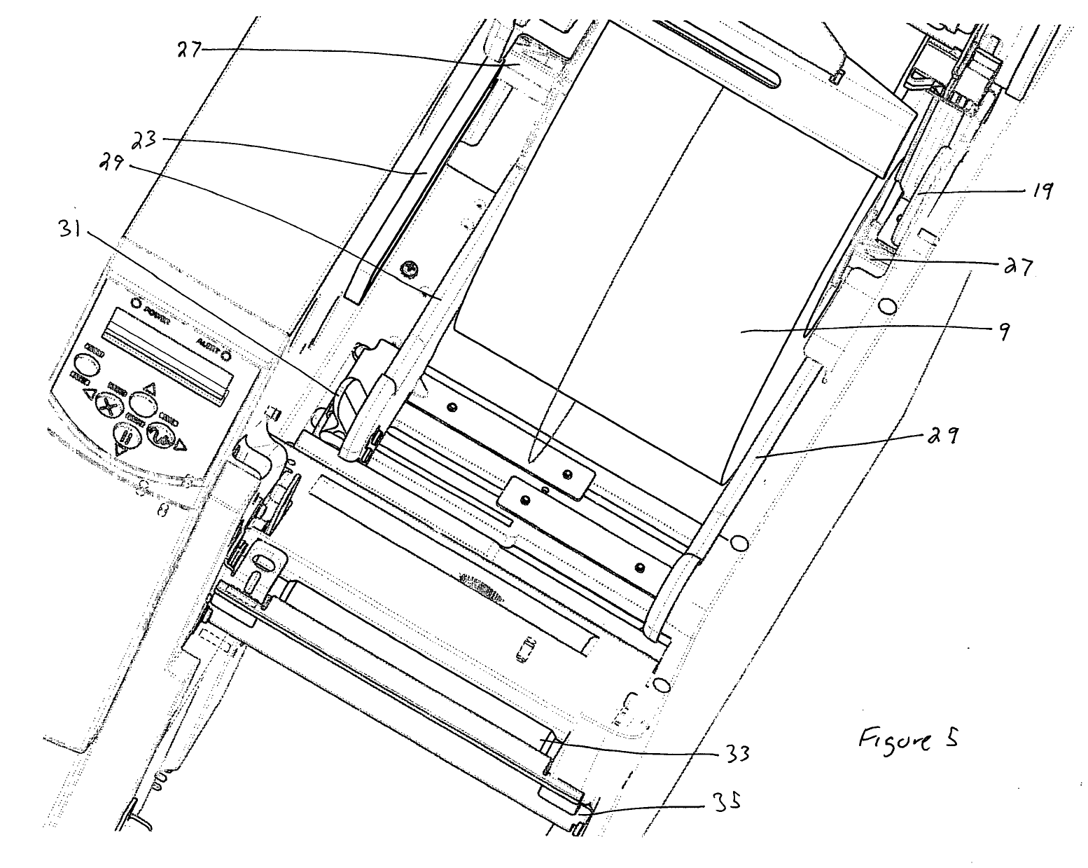

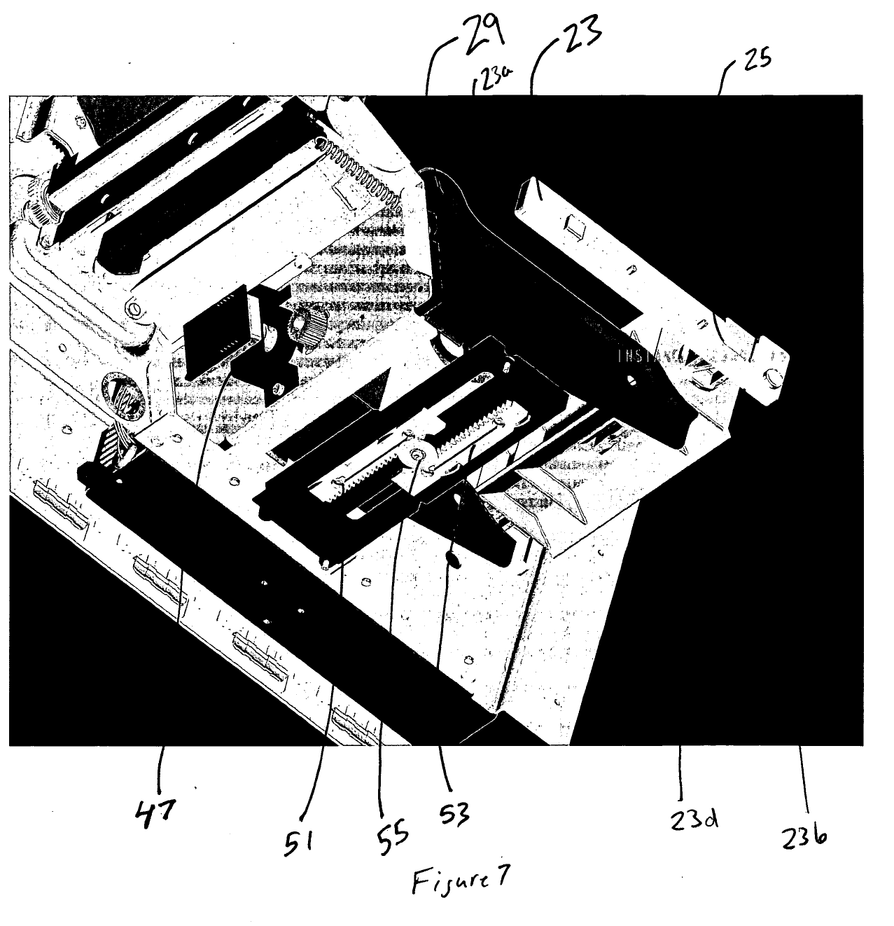

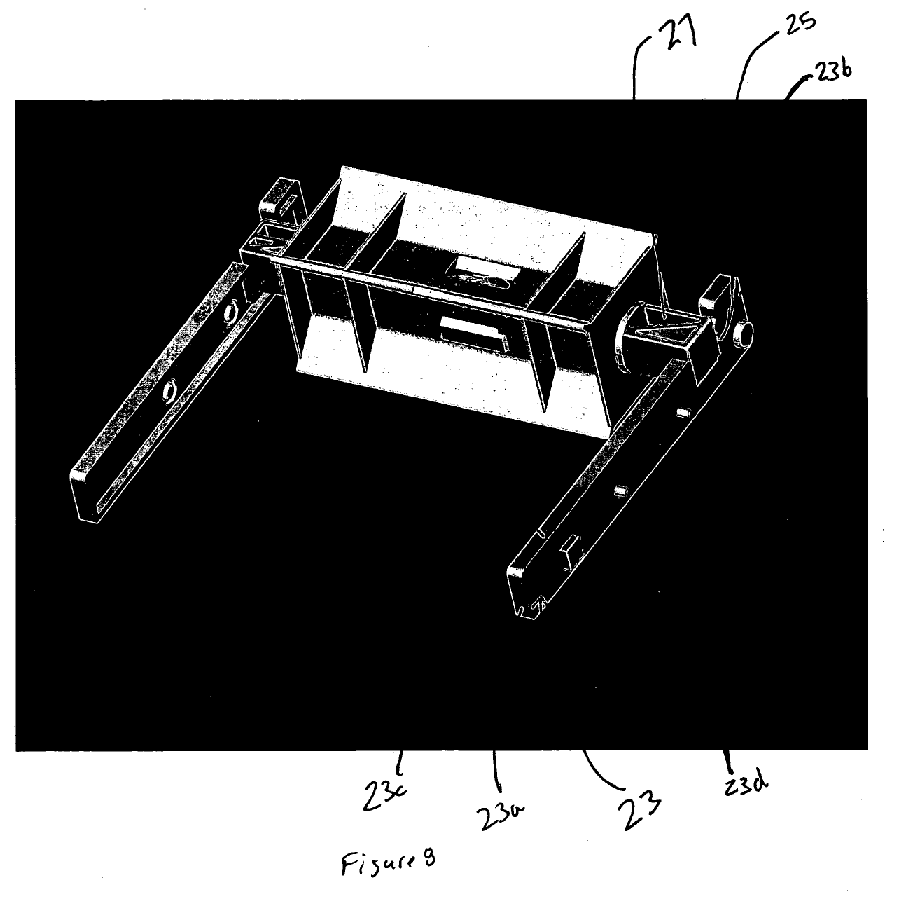

The media cavity 21, shown in greater detail in FIG. 4 (top cover 3 removed for clarity) and FIGS. 5-8, has a pair of parallel media guide rail(s) 23 positioned across from each other on either side. The rails have a first end 23a located proximate to a front of the printer and opposed second ends 23b distal from the front of the printer. Depression(s) 25 formed in the media guide rail(s) 23 at a rear position near the distal ends to locate a media spindle 27 into an operating position. While the top and bottom edges, 23c and 23d, respectively, of the rails may be parallel, in some embodiments, the top edges 23c slope from the proximal end 23a to the distal end 23b, such that the edges are non-parallel. In some configurations, the top edge slopes toward said bottom edge from the proximal end to the distal end. In this configuration, the rails assist the user in directing the spindle 27 of the media to the depressions 25 in the rear position of the rails.

As illustrated, the depression is shaped to engage the spindle 27 so as to resist rotation of the spindle. In the illustrative embodiment, the depressions are square in shape to engage the square shape of the spindle. However, various other shapes are contemplated. Generally, however, the depressions include a surface for engaging and resisting rotation of the spindle.

To load media 9, an operator inserts the media spindle 27 through a roll of media 9, opens the top cover 3 and inserts the media 9 and media spindle 27 into the media cavity 21 from the front of the label printer 1. As the media 9 and media spindle 27 are pushed farther back into the media cavity 21, the media spindle 27 ends engage and move along the media guide rail(s) 23. When the media spindle 27 ends encounter the depression(s) 25, the media spindle 27 drops into place, securing the media spindle 27 at the operating position, and thereby the media 9 from further movement within the media cavity 21.

Once located within the media cavity 21, the media 9 is centered upon the media spindle 27 by a pair of movable centering guides 29 as shown in FIG. 5. The centering guides 29 operate in unison towards and away from each other, the movement relative to a centerline of a media path through the media cavity 21. The centering guide(s) 29 may be spring biased towards each other to automatically center the media 9 within the media cavity 21 as it is inserted, or include a manual mechanism such as a manual stop spring lever 31 that is depressed to allow centering guide 29 movement but otherwise fixes the centering guide(s) 29 at a selected media 9 loading and or label printer 1 operation position.

To complete media loading, the operator lays a leader portion of the media 9 from the media roll across the platen 33 and closes the top cover 3, thereby sandwiching the media 9 between the print head 11 and the platen 33, ready for print operations.

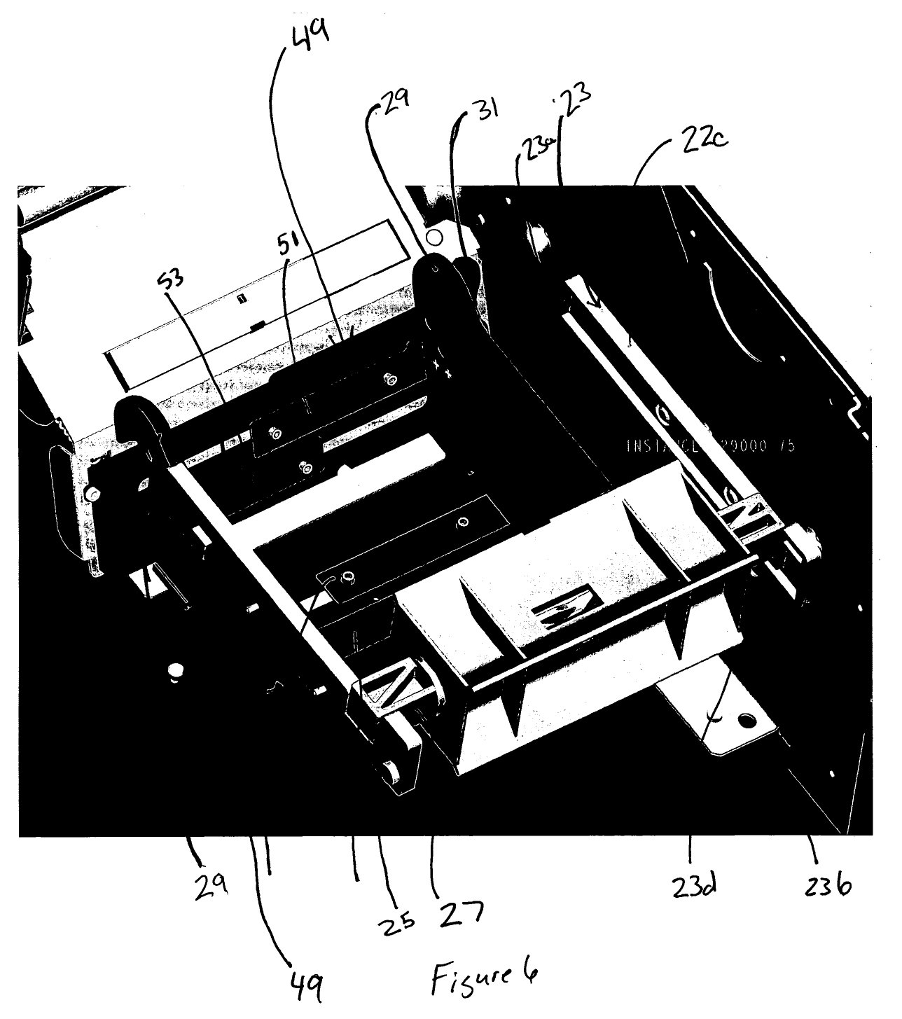

A liner, which carries each of the labels, may be torn off along with each printed label at a tear bar proximate the platen 33 or, as shown in FIG. 6, a peel bar 35 adapted to separate the liner from the label may be used in place of the tear bar. The continuous liner, separated from each label by passage across the peel bar 35 may be routed to a liner take-up reel 37 for accumulation and eventual removal during media exchanges.

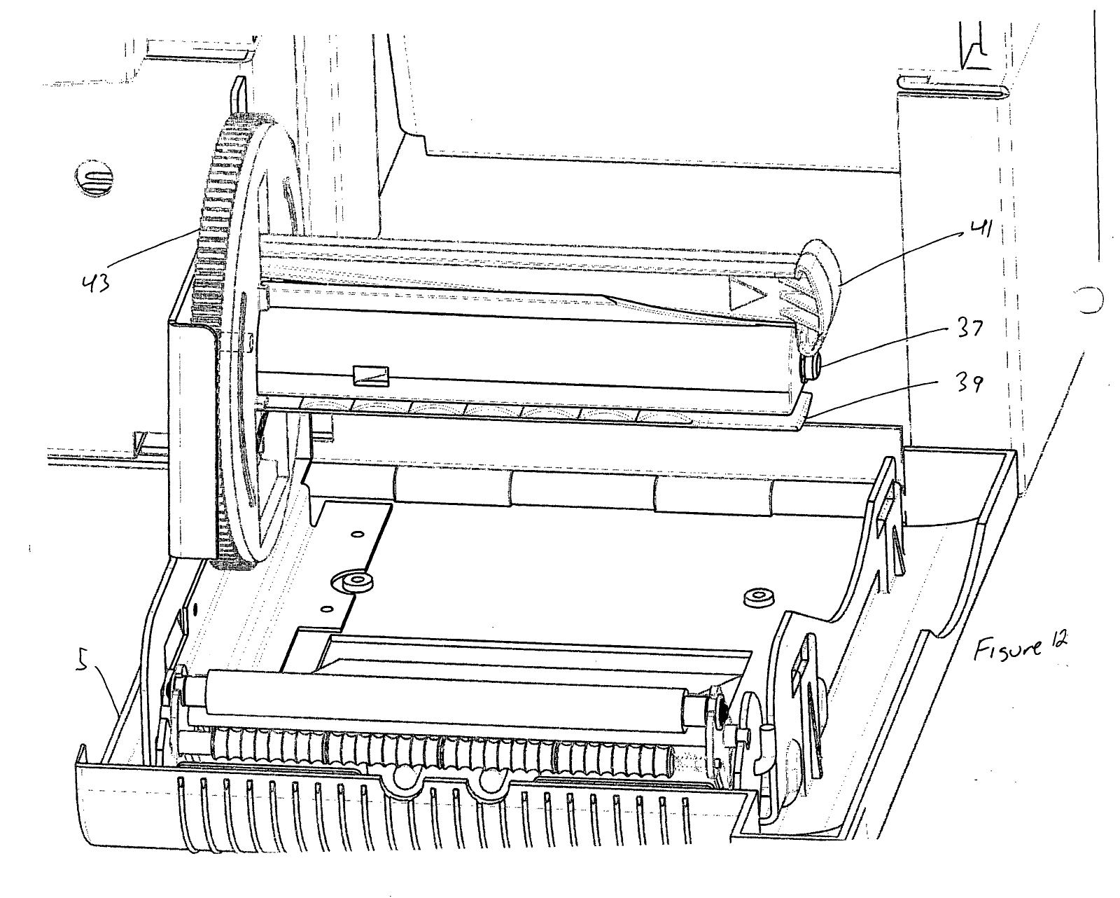

As shown in FIG. 12, the liner take-up reel 37 is mounted to the front door 5 to facilitate label printer 1 front end access to the liner roll which accumulates upon the take-up reel 37 during label printer 1 operation. The liner take-up reel 37 incorporates a clip 39 adapted to receive and grasp an initial end portion of the liner. To allow the clip 39 to grasp a liner from media 9 of varying widths, the clip 39 extends the length of the take-up reel 37 and is biased towards a center of the take-up reel 37. A ramp lever 41 is adapted for movement along a longitudinal axis of the take-up reel 37. During movement away from the take-up reel 37, the ramp lever 41 interacts with a ramp surface within the take-up reel 37 to also move radially inward with respect to the take-up reel 37, thereby decreasing the effective diameter of the take-up reel 37 and allowing easy removal of the accumulated liner roll. A spring or the like is used to bias the ramp lever 41 into a steady state position of maximum take-up reel 37 diameter. The radial movement of the ramp lever 41, when pulled along the longitudinal axis of the take-up reel 37, is described in greater detail in U.S. Pat. No. 6,020,906 by Adams et al, issued Feb. 1, 2000 and hereby incorporated by reference in the entirety.

The take-up reel 37 mounting position upon the front door 5 is adapted whereby as the door is closed, a gear 43 of the take-up reel 37 engages a drive sprocket 45 (see FIG. 2) which drives the take-up reel during label printer 1 operation. Also, the arc which the take-up reel 37 moves through during front door 5 movement is adapted whereby an initial tension applied to the liner when attached to the clip 39 of the take-up reel 37 at the front door 5 open position is maintained at the front door 5 closed position. Thereby, the additional step during media loading where the liner take-up reel 37 is used is simply to pull the media across the platen 33 and peel bar 35 down to the take-up reel 37 where it is inserted into the clip 39 and the take-up reel 37 spun to wind up any slack in the media/liner. When the front door 5 is closed, the label printer 1 is ready for operation.

The simplified media path of a printer according to the invention reduces the opportunities for media jams. Should a media jam occur, ready access without pinch points upon opening of the top cover 3 and front cover 5, if present, allows for quick recovery, reducing the chances that an operator attempting to clear the media path will damage the printer.

The media 9 centering action of the movable centering guides 29 ensures that media 9 of any desired width is centered within the label printer 1. Thereby, the media 9 is also centered upon the print head 11. Because the print head 11 is always centered upon the media 9, the suspension of the print head 11 may be simplified to comprise a single spring biasing the print head 11 towards the media 9 and platen 33. Further, the top cover 3 is not required to have an elaborate latch mechanism locking the forward end of the top cover 3 into a coplanar relationship with the media path and or platen 33. The top cover 3 pivots into the operation position under the force of gravity from the weight of the top cover 3, print head 11 and print ribbon structures.

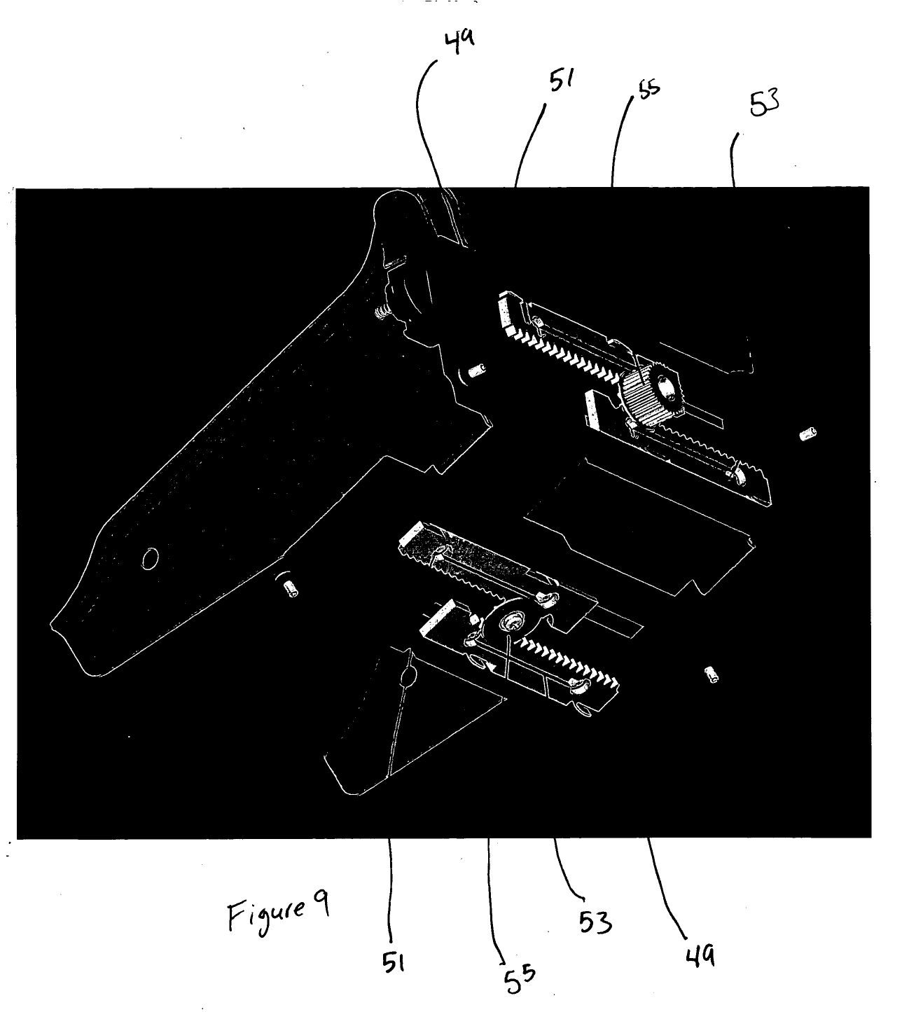

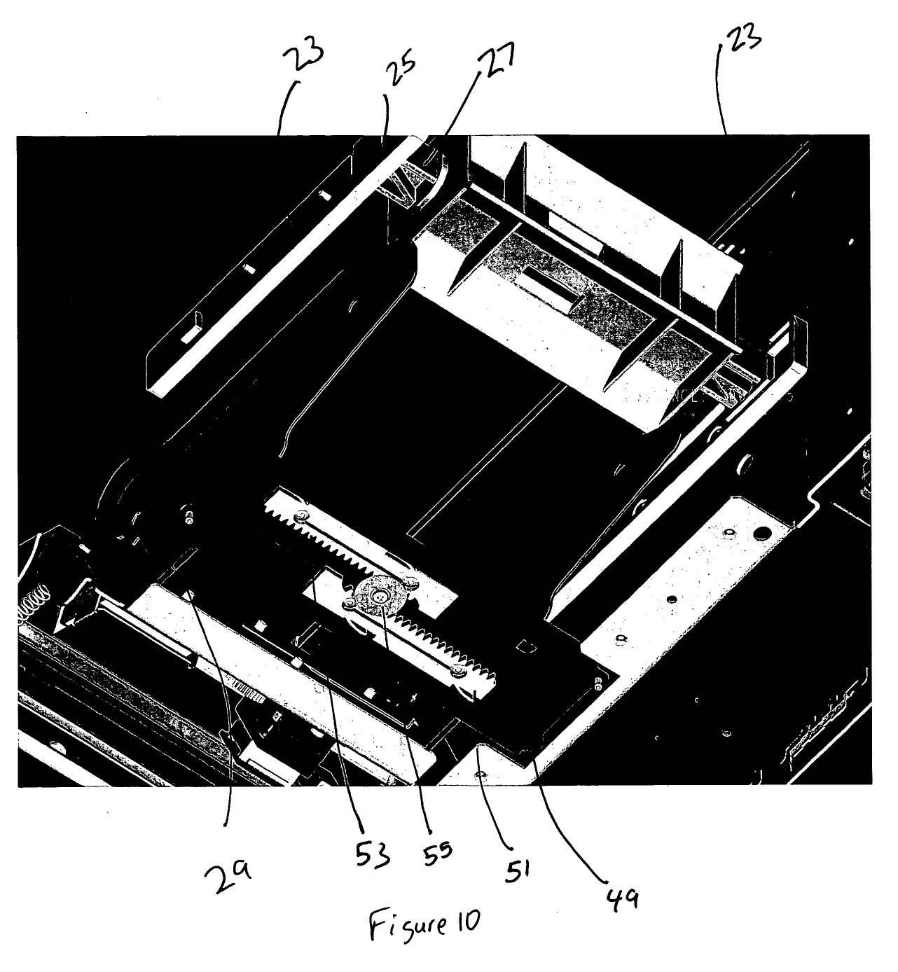

With reference to FIGS. 4-10, the centering guides 29 includes one or more sets of centering mechanism 49 respective upper and lower racks, 51 and 53. The racks are connected to each other by one or more pinions 55. Both the racks and pinions include gears that intermesh. In this configuration, when one of the centering guides 29 is moved laterally, the other centering guide is moved in an opposite direction by action of the one or more pinions. In some embodiments, a spring or other biasing means may be used to bias the centering guides toward each other. Other configurations of the centering guides are contemplated. Various such embodiments are disclosed in U.S. Patent Application No. 60/630,647, filed Nov. 24, 2004, entitled: “Self-Centering Media Support Assembly and Method of Using the Same” to Amani et al.; the contents of which are enclosed herein by reference.

To allow automated printing upon the media 9 of varied widths, the label printer 1 employs a device for determining media width, such as center justified printing logic. The desired print image is located upon the loaded media 9 by sensing the position of one of the side edges of the media 9 and then calculating there from the extent and position of the media 9 (which is known to be centered within the media path). The individual print elements of the print head 11 can then be logically identified and energized as necessary to form the desired indicia. Center justified printing can also contribute to extended useful life of the print head 11. Where prior left justified printers typically suffer degradation of the left side print elements first, due to their heavy use during printing of label borders independent of the media width used, center justified printing spreads the label border printing duty across the print head 11, to different locations depending upon each different width of the media 9 that may be loaded.

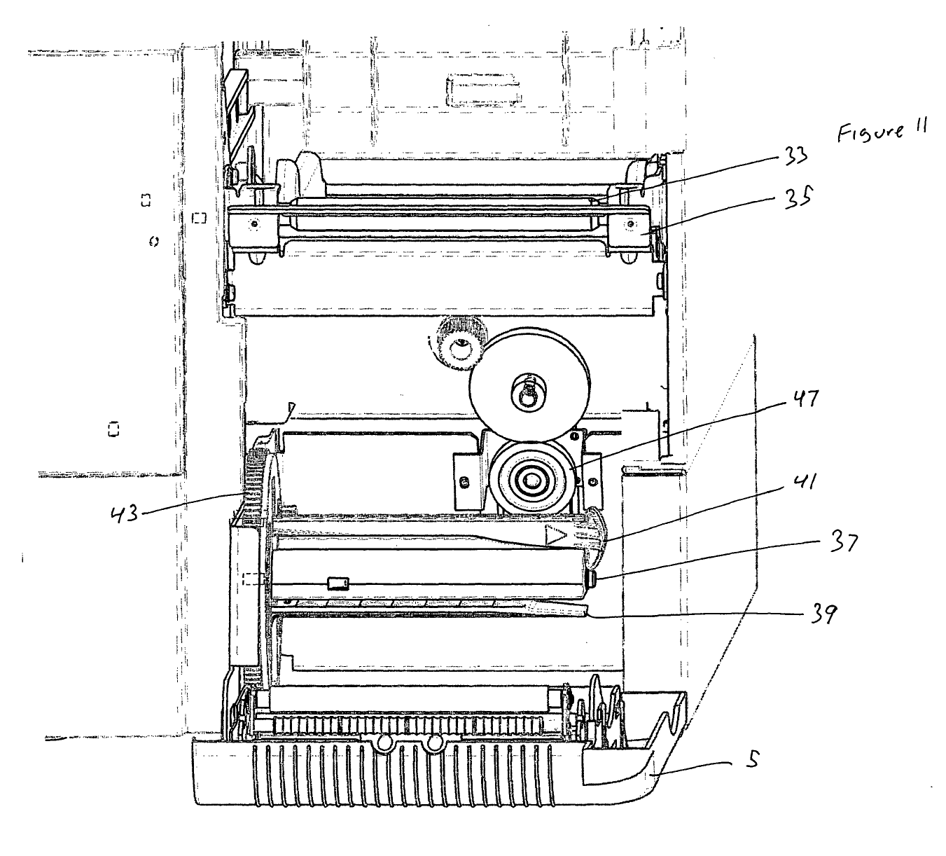

One method of sensing the location of the media 9 side edge is to detect the position of the movable centering guides 29 once the media 9 is loaded. A detector may be employed to detect the location of one of the side edges. For example, an encoder 47 (see FIG. 11), for example a multiple turn precision rheostat, coupled by, for example, one or more gears to a pinion used to maintain the opposing movement of the movable guides 29 may be used to create a variable signal level output which is proportional to the loaded media 9 width. Because the linkage between the encoder 47 and the media edge position is mechanical, negative effects from media fibers, dust or other forms of environmental fouling typically encountered below the media path are reduced, relative to optical edge detection.

It is understood that other systems and methods may be used to determine the width of the media. For example, the racks, 51 and 53, of the centering guides 29 and the pinion 55 may be conductive. In this instance, a current may applied such that current flows along one rack, through the pinion, and along the other rack for measuring resistance variations. The closer the centering guides are relative to each other, the lower the resistance along the racks. These measurements could be calculated for different centering guide separations.

In an alternative embodiment light sources and detector arrays may be positioned in the printer to detect the edges of the roll media and thus determine media width.

In another alternative embodiment, a light and detector may be placed on opposite sides of one of the racks so as to detect passage of gaps between the teeth of the gears located on the rack, as the rack is moved laterally. This lateral movement could then be used to determine the displacement of the centering guides from the center reference point, which again indicates media width.

As mentioned, the printer includes center justified printing logic to determine the width of the media installed in the printer. The logic includes a reference point identifying the center point of the centering guides 29. The logic receives a location of one of the centering guides and subtracts this location from the center reference point. This calculated value represents half of the media width, from which the printer logic can determine the width of the media. The center justified printing logic can take any form such as a processing element in form of a series of logic gates, ASIC, microprocessor operating on computer software, etc.

The center justified printing logic and the centering guides are used in the printer to provide reference points for the printer controller when printing on the media. The centering guides ensure that the media is properly centered in the printer, while the center justified printing logic determines the media width. This information is used to properly format data so that it will fit on to the media when printed, as well as aid in determining locations on the media where data will be printed.

Furthermore, the media width information could also be transmitted remotely from the printer. For example, the information could be transmitted via cable, network, wireless, etc. to a host computer to indicate the width of the media loaded in the printer. The printer could also include an RFID tag located in the printer that could transmit media width data to an RFID reader.

The present invention provides a reliable and cost effective label printer with ease of use and reduced space requirements. In continuous printing applications, multiple printers may be located compactly side by side. Media loading is greatly simplified; the serpentine media path associated with prior side media loading printers is eliminated. Center justified printing simplifies many structures throughout the printer, improving reliability and reducing manufacturing costs.

Table of Parts

| | |
|---|---|
| 1 | label printer |
| 3 | top door |
| 5 | front door |
| 7 | media window |
| 9 | media |
| 11 | print head |
| 13 | ribbon supply spindle |
| 15 | ribbon take-up spindle |
| 17 | frame |
| 19 | pivot point |
| 21 | media cavity |
| 23 | media guide rail(s) |
| 25 | depression(s) |
| 27 | media spindle |
| 29 | movable centering guides |
| 31 | spring lever |
| 33 | platen |
| 35 | peel bar |
| 37 | take-up reel |
| 39 | clip |
| 41 | ramp lever |
| 43 | gear |
| 45 | drive sprocket |
| 47 | encoder |
| 49 | centering mechanism |
| 51 | upper rack |
| 53 | lower rack |
| 55 | pinion |

Where in the foregoing description reference has been made to ratios, integers or components having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

1. A printer for printing indicia upon media, comprising:
a frame defining a media cavity having a top cover;
a print head coupled to the top cover;
the top cover pivotable to an open position above the printer to provide access for loading of the media into the media cavity from a front end of the printer;
at least one media guide rail located in the media cavity for engaging a spindle on which the media is located, wherein the media guide rail supports the media as it is pushed from a front of the media cavity to an operating position proximate the back of the media cavity.

2. The printer of claim 1, wherein said guide rail comprises a depression formed in the guide rails that define the operating position.

3. The printer of claim 2, wherein said depression comprises a surface for retaining the spindle and resisting rotation of the spindle.

4. The printer of claim 1, wherein said guide rail comprises top and bottom edges extending between opposing first and second ends at a depression adjacent to said second end defined in said top edge, wherein said top and bottom edges are non-parallel with respect to each other.

5. The printer of claim 1 comprising a pair of media rail guides located on opposing sides of the cavity for supporting the media.

6. The printer of claim 1, further comprising at least one centering mechanism, centering mechanism comprising:
at least two centering guides in the media cavity, said media centering guides adapted to move towards and apart from each other in unison and operable to center the media between them.

7. The printer of claim 1, wherein said centering mechanism further comprises at least one set of racks respectively coupled to the centering guides and at least one pinion in communication with the racks, wherein as the racks move laterally relative to each other via said pinion, said centering guides are repositioned relative to each other.

8. The printer of claim 6, further including an encoder coupled to the movable centering guides.

9. The printer of claim 6, further comprising a detector in communication with at least on of said media centering guides to detect a distance that said guide is from a reference position.

10. The printer of claim 9 further comprising a processing element in communication with said detector, wherein said processing element determines a width of the media based on the distance that said guide is from a reference position.

11. The printer of claim 1, further including a front door pivotable between an open and a closed position; and a take-up reel mounted on the front door.

12. The printer of claim 11, further including a drive sprocket which engages a gear of the take-up reel when the front door is in the closed position.

13. The printer of claim 11, further including a clip extending between the gear and an end of the take-up reel.

14. The printer of claim 11, further including a ramp lever movable in a direction coaxial with a longitudinal axis of the take-up reel;
the ramp lever operating to decrease a diameter of the take-up reel as it is moved.

15. A printer for printing indicia upon media, comprising:
a frame defining a media cavity having a top cover;
a print head coupled to the top cover;
the top cover pivotable to an open position above the printer to provide access for loading of the media into the media cavity from a front end of the printer;
at least one media guide rail located in the media cavity for engaging a spindle on which the media is located, wherein the media guide rail supports the media as it is pushed from a front of the media cavity to an operating position proximate the back of the media cavity;
a pair of movable centering guides in the media cavity;
the media centering guides adapted to move towards and apart from each other in unison;
the media centering guides operable to center the media between them;
a front door pivotable between an open and a closed position; and
a take-up reel mounted on the front door.

16. A printer for printing indicia upon media, comprising:
a frame defining a media cavity supporting the media centered with respect to a print head;
the print head mounted to a top cover pivotable to enable media loading from a front of the printer; and
a take-up reel mounted on a front cover.

17. A printer for printing indicia upon media, comprising:
a frame defining a media cavity;
a print head coupled to said frame for printing on the media;
at least one centering mechanism, said centering mechanism comprising at least two centering guides in the media cavity, said media centering guides adapted to move towards and apart from each other in unison and operable to center the media between them;
a detector in communication with at least on of said media centering guides to detect a distance that said guide is from a reference position; and
a processing element in communication with said detector, wherein said processing element determines a width of the media based on the distance that said guide is from a reference position.

18. The printer of claim 17, wherein said detector is an encoder.

19. The printer of claim 17, wherein said centering mechanism further comprises at least one set of racks respectively coupled to the centering guides and at least one pinion in communication with the racks, wherein as the racks move laterally relative to each other via said pinion, said centering guides are repositioned relative to each other.

20. The printer of claim 17, wherein said processing element further communicates the media width to a remote location.
